(19) United States
(12) Patent Application Publication
(10) Pub. No.: US 2019/0276597 A1
(43) Pub. Date: Sep. 12, 2019

(54) TRANSPARENT MOULDED PARTS HAVING REDUCED THICKNESS

(71) Applicant: COVESTRO DEUTSCHLAND AG, Leverkusen (DE)

(72) Inventors: Martin DÖBLER, Düsseldorf (DE); Rolf WEHRMANN, Krefeld (DE); Anke BOUMANS, Goch (DE); Lucia WINKLER, Wermelskirchen (DE); Martin BURGER, Solingen (DE)

(21) Appl. No.: 16/334,968

(22) PCT Filed: Sep. 18, 2017
(86) PCT No.: PCT/EP2017/073506

§ 371 Date: Mar. 20, 2019

(30) Foreign Application Priority Data
Sep. 22, 2016 (EP) 16190085.7

(51) Int. Cl. C08G 64/06; C08K 5/00; F21S 41/20; F21S 41/141

(52) U.S. Cl. CPC C08G 64/06; C08K 5/005; B29C 45/0001; F21S 41/141; F21S 41/28

(57) ABSTRACT

The invention relates to the use of a composition A based on aromatic polycarbonate, containing a) aromatic polycarbonate, wherein the polycarbonate has an average weight-average molecular weight Mw of 22000 g/mol to 27000 g/mol, determined by means of gel permeation chromatography according to DIN 55672-1:2007-08, and calibrated in relation to bisphenol A-polycarbonate standards using dichloromethane as an eluent, and wherein the polycarbonate has 0 to max. 19 mol % carbonate units of formula (1) where R₁, R₂, R₃, R₄, R₅, R₆, R₇ and R₈ independently represent H or C₁- to C₆-alkyl, and b) 0 to less than 0.2 wt. % of a UV absorber or a UV absorber mixture, in relation to the total weight of the polycarbonate composition, in order to increase the flow path-wall thickness ratio in the production of a moulded part by means of injection moulding, as well as correspondingly producible thin-walled transparent moulded parts, preferably lamp covers, in particular headlamp covers, having a maximum wall thickness of 3 mm, in particular those with a thickness of max. 1.9 mm. The invention also relates to headlamps comprising these headlamp covers, and an LED light source, and a method for producing the headlamp covers.

### CROSS REFERENCE TO RELATED APPLICATIONS

This application is a national stage application under 35 U.S.C. § 371 of PCT/EP2017/073506, filed Sep. 18, 2017 which claims benefit of European Application No. 16190085.7, filed Sep. 22, 2016 and which are incorporated herein by reference.

### FIELD OF THE INVENTION

The present invention relates to the use of specific polycarbonate compositions with the purpose of improving the flow distance to wall thickness ratio in the production of transparent molded articles, preferably light covers, especially a headlamp cover, by means of injection molding. This is of particular relevance for the production of light covers for main headlamps of motor vehicles. The present invention therefore also relates to corresponding transparent molded articles, preferably light covers, especially headlamp covers, to headlamps comprising these headlamp covers and an LED light source, and to a process for producing the transparent molded articles and especially headlamp covers.

### BACKGROUND OF THE INVENTION

Modem front headlamps in motor vehicles generally include one or more lighting means, optical elements within the headlamp, such as lenses or reflectors that produce the desired light profile, various decorative elements within the headlamp, and a transparent cover.

For reasons of weight, but also for reasons of design freedom, the transparent covers of modem automotive headlamps are produced almost exclusively from thermoplastics. For the front headlamps, there is additionally also high mechanical stress as a result of stone-chipping and sand abrasion. Therefore, polycarbonate covers with scratch-resistant lacquer have become established. This application is known and described in the literature (e.g. DE 2 826 087 A1).

A disadvantage of the known polycarbonate-based headlamp covers is that their wall thickness cannot be as thin as desired. This is because the polycarbonate itself must have a certain molecular weight in order to impart sufficient mechanical properties such as stone-chip resistance and heat distortion resistance to the headlamp cover. However, the effect of this molecular weight is that the viscosity of the polycarbonate melt is so high that the ratio of the flow distance of the polycarbonate melt to the desired resulting wall thickness of the molded article is limited to about 150. This is known to the person skilled in the art and is also described in technical data sheets, for example KU28012-0501 from Makrolon® AL2447 and Makrolon® AL2647

One effect of a limited flow pathway with low wall thickness is that molded articles of a certain size cannot be produced at all by standard injection molding since the flow front does not flow far enough to fill the cavity. Alternative technologies, for example a gate system front and center of a cover rather than a lateral gate, lead to optical and mechanical penalties that would be much worse than current covers and are therefore not an option. Moreover, there are known variothermal injection molding processes (for example from Roctool) in which dynamic temperature control of the mold during the injection molding cycle makes it possible to extend the flow distance. However, these processes are very complex and energy-intensive. Moreover, this process can also give molded articles that do not satisfy all optical demands.

Furthermore, injection-compression molding methods with special embossing molds can extend the flow pathways in that the mold is not completely closed in the injection operation and hence the cavity volume is enlarged. Only toward the end of the injection phase is the mold closed, and the molded article is shaped under the closed pressure. The implementation of this process is very complex and it is not employable for every molded article geometry.

Attempts to increase the injection pressure in conventional injection molding in the production of thinner molded articles failed because this led to higher internal frozen-in stresses after the injection molding and hence to an unacceptable reduction in service life of the molded articles. The standard polycarbonate compositions on the market can likewise be used only at injection temperatures (“melt temperature”) of around 300° C. since partial breakdown of the polymers and color change is otherwise observed. This leads in turn to molded articles having worsened mechanical and optical properties.

DE 60 2004 005 730 T2 describes the production of a 3 mm-thick automobile headlamp lens, in which a mixture of a polycarbonate resin having a molecular weight M_{w} of 29 900 g/mol and a polycarbonate resin having a molecular weight M_{w} of 21 900 g/mol is used as polycarbonate. The UV stabilizer 2-(2H-benzotriazol-2-yl-4-(1,1,3,3-tetramethylbutyl)phenol is added to this mixture at 0.27% by weight, based on the total weight of the polycarbonate composition. The sheets are molded according to the standard processing conditions as defined for the material in the technical data sheet. A comparison used was the LEXAN® LS2 product, which is likewise UV-stabilized according to the data sheet.

A similar composition is also disclosed in DE 603 17 054 T2 (mixture of a polycarbonate resin having a molecular weight M_{w} of 29 900 g/mol and a polycarbonate resin having a molecular weight M_{w} of 21 900 g/mol, addition of 0.27% by weight of 2-(2H-benzotriazol-2-yl-4-(1,1,3,3-tetramethylbutyl)phenol).

EP 0 779 327 A1 also describes the use of UV-stabilized LEXAN® LS2 as substrate for headlamp covers.

The focus of many prior art documents is on the improvement of the properties of polycarbonate molded articles by means of additional coatings for example (see, for example, DE 2 826 087 A1, DE 100 18 935 A1, DE 693 17 237 T2, EP 1 164 005 A1 and WO 99/59793 A1).

None of these documents makes any statements as to how molded articles of minimum thickness, for the purpose of saving weight, can be produced with the same mechanical and optical properties.

### DETAILED DESCRIPTION OF THE INVENTION

Proceeding from this prior art, it was an object of the present invention to remedy at least one disadvantage, preferably all disadvantages, of the prior art. More particularly, the problem addressed by the present invention was that of achieving an elevated flow distance to wall thickness ratio compared to polycarbonate compositions used conventionally, particularly for headlamps or headlamp covers, such that minimum wall thicknesses can be achieved, but at the same time with minimum resultant deterioration in the mechanical and/or optical properties of the molded article. Furthermore, it was preferably an object of the present invention to provide a molded article, especially a headlamp cover, which has a thickness of not more than 3 mm, preferably not more than 2.9 mm, and is preferably thinner than 2.5 mm, especially thinner than 2 mm, and at the same time meets the demands on a headlamp cover of a motor vehicle from a mechanical and optical point of view. At the same time, in particular, there is preferably to be maintance of, preferably improvement in, optical properties in relation to transmittance, preferably at 400 nm, color, residual cloudiness and/or defects perceptible to the eye. More preferably, all these optical properties are to be maintained, preferably improved. In the case of the mechanical properties, stone-chip resistance and/or heat distortion resistance in particular are to be maintained, preferably improved.

These objects are partly or wholly achieved by use of a polycarbonate-based composition A, comprising

a) aromatic polycarbonate, where the polycarbonate has a mean weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, and where the polycarbonate includes 0 to 19 mol % of carbonate units of the formula (1)

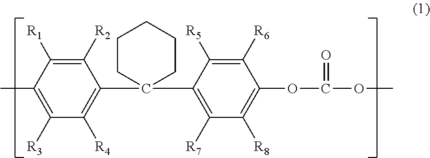

where R₁, R₂, R₃, R₄, R₅, R₆, R₇ and R₈ are independently H or C₁- to C₆-alkyl, and is preferably free of carbonate units of the formula (1), and
b) 0% to less than 0.2% by weight of a UV absorber or a UV absorber mixture, based on the total weight of the polycarbonate composition,
for increasing the flow distance to wall thickness ratio in the production of a transparent molded article, preferably a light cover, more preferably a headlamp cover, especially for a motor vehicle, by means of injection molding.

Preference is given here to achieving flow distance to wall thickness ratios of 180 to 500, further preferably of 250 to 500.

Carbonate units of the formula (1) are obtained, for example, from aromatic diols such as 4,4′-cyclohexylidenebisphenol (bisphenol Z).

The polycarbonate is further preferably also free of siloxane units.

More preferably, the polycarbonate includes more than 80 mol % of, even more preferably at least 90 mol % of, especially at least 95 mol % of, even further preferably at least 98 mol % of and exceptionally preferably exclusively bisphenol A-based carbonate units, based on the total amount of carbonate units.

The comparison is based on the achievable flow distance to wall thickness ratio for a composition A compared to the achievable flow distance to wall thickness ratio for an otherwise analogous composition B containing at least 0.2% by weight of a UV absorber or a UV absorber mixture.

“Polycarbonate-based” or “polycarbonate composition” in the present context and everywhere else in the description of the invention means that the polymer component that constitutes the major proportion of all components of the overall composition, polycarbonate, preferably aromatic polycarbonate, most preferably bisphenol A-based polycarbonate, accounts for a proportion of preferably at least 80% by weight, further preferably at least 90% by weight, more preferably at least 94% by weight, even more preferably at least 98% by weight, of polycarbonate, especially bisphenol A-based polycarbonate, based on the overall composition.

The stated molecular weight M_{w} is based on the average molecular weight M_{w} of all polycarbonates present in the polycarbonate-based composition, meaning that the stated weight-average molecular weight relates to the average value of M_{w} for all polycarbonates. For example, additives can be introduced using a polycarbonate powder having a weight-average molecular weight outside the range specified, provided that only the average molecular weight of the polycarbonate present is within the range specified. Preferably, aside from the polycarbonate, the composition does not include any further polymer.

It has been found that, surprisingly, the flow distance to wall thickness ratio can be increased when the content of UV absorber or UV absorber mixture is minimized. Contrary to expectations, higher temperatures of the polycarbonate melt are thus achievable in the production of the molded articles, with both excellent mechanical and optical properties of the resulting molded article. In particular, the molded articles are suitable for use as light covers, most preferably for headlamp covers. More particularly, the combination of these headlamp covers with LED light or laser light as headlamp light is advantageous since no UV protection is required for this light. For protection from insolation, it is possible to apply, for example, a UV absorber-containing scratch-resistant layer.

The effect of the higher achievable flow distance to wall thickness ratio is that the extended flow pathway also makes it possible to achieve large and at the same time thin molded articles without difficulty by means of injection molding. Thus, molded articles of the invention are producible in more flexible and simultaneously thin form irrespective of their size and configuration. The elevated flow distance to wall thickness ratio is thus associated with the possibility of a weight saving in components, especially in headlamp covers. The dwell time of the melt in the injection molding machine should preferably, as is known to the person skilled in the art, be kept as short as possible.

The invention therefore also provides a transparent molded article, preferably a light cover, especially a headlamp cover, especially for a main headlamp of a motor vehicle, especially a car or truck, having a wall thickness of not more than 3 mm, preferably not more than 2.9 mm, further preferably of not more than 2.2 mm, even further preferably of not more than 1.9 mm, especially preferably of not more than 1.6 mm, most preferably of not more than 1.5 mm, composed of a composition based on aromatic polycarbonate and comprising a polycarbonate having a weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, wherein the polycarbonate includes 0 to not more than 19 mol % of carbonate units of the formula (1)

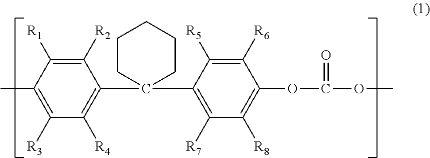

where R₁, R₂, R₃, R₄, R₅, R₆, R₇ and R₈ are independently H or C₁- to C₆-alkyl, and is preferably free of carbonate units of the formula (1), and containing less than 0.2% by weight of a UV absorber or a UV absorber mixture. The extremely low thicknesses have to date been unachievable with the compositions utilized for headlamp covers in the prior art, especially in the case of main headlamps. The same is true of other transparent molded articles of a certain area, especially also from the field of glazing, in which inventive flow distance to wall thickness ratios have not been achieved to date.

The invention likewise provides a headlamp comprising the molded article of the invention as headlamp cover, especially in combination with an LED light source or a laser light source, preferably an LED light source.

In addition, it has been found that the elevated processing temperatures in the production of the molded articles of the invention are advantageous in the injection molding process per se. For example, it is thus possible to obtain molded articles with fewer weld lines. Weld lines are disadvantageous both with regard to optical properties and mechanical properties in molded articles. Such a high temperature in injection moldings can also additionally have an advantageous effect with regard to avoidance of flow marks, frozen-in stresses and other injection molding defects.

This means firstly that the minimization of the content of UV absorber or UV absorber mixture makes it possible to use polycarbonate melts having lower polycarbonate degradation than comparable polycarbonate melts with higher proportions of UV absorber or UV absorber mixture. Therefore, the polycarbonate melts used in accordance with the invention can be heated to a higher level with comparable, preferably lower, degradation of the polycarbonate compared to comparable polycarbonate melts with higher proportions of UV absorber or UV absorber mixture. The effect of this is that thin-walled molded articles simultaneously having the same mechanical properties, preferably better mechanical properties, than comparable molded articles with higher proportions of UV absorber or UV absorber mixture are obtained. At the same time, stone-chip resistance is preferably maintained or improved.

Secondly, the molded articles can still have excellent optical properties. Parameters of particular importance for light covers, especially for headlamp covers, are optical properties in relation to transmission, preferably at 400 nm, color, residual cloudiness and/or defects perceptible to the eye. In the case of transmission, important parameters are transmission Ty in the visible region and also transmission at 400 nm, both preferably determined to ISO13468-2 2006-07 at a layer thickness of 4 mm. Transmission at 400 nm indicates the extent of yellowing. The molded articles obtained in accordance with the invention, with a thin wall, have the same, preferably improved, optical properties by comparison with molded articles having higher proportions of UV absorber or UV absorber mixture. More particularly, the molded articles obtained in accordance with the invention with an improved flow distance to wall thickness ratio, in spite of the high flow distance to wall thickness ratio which is preferably achieved by temperatures of the polycarbonate melt above 300° C., have the same, preferably improved, optical properties by comparison with molded articles made from polycarbonate melts having higher proportions of UV absorber or UV absorber mixture. Polycarbonate melts having a higher proportion of UV absorber or UV absorber mixture that are heated to temperatures above 300° C. result in molded articles having a somewhat elevated yellow tinge. This can especially be detected via a low transmission value at 400 nm. Such a yellow tinge can be minimized in accordance with the invention.

According to the invention, the “flow distance to wall thickness ratio” is defined as follows: The flow distance is the longest distance within a particular molded article that the polymer melt has to cover away from the feed point in order to completely fill the molded article. The flow distance is reported in mm. It is measured on the solidified polycarbonate melt, i.e. the finished component. As a result of three-dimensional configurations of the molded article, the flow distance can be longer than the direct connection from the feed point to the furthest removed point in the molded article. It can be helpful here when the flow distance is determined by means of commercial simulation software. Alternatively, the flow distance can also be determined experimentally by means of a filling series. More preferably, the flow distance is simulated. It is especially preferable here when the Autodesk® Moldflow® software is used. Particular preference is given to the AMI2016 P3 version, very particular preference to the AMI2018.1 version, of this software. The method of determining the flow distance is familiar to the person skilled in the art. All gate types known to the person skilled in the art are suitable in principle, for example point gate, tunnel gate or film gate. Preference is given to using film gate systems. If the gate systems are those in which there is a broad melt front (and not a point), the flow distance is further determined by the longest distance within the molded article. A radial distribution of the melt from the feed point is assumed here. In this case too, the flow distance can be determined by commercial simulation software. More preferably, it is determined proceeding from the feed point as far as the point in the molded article furthest removed from said point.

The mold temperature is matched to the polycarbonate composition to be used. It is preferably 60-160° C., more preferably 80-120° C. and especially preferably 90-110° C. The temperature of the mold is preferably constant.

The wall thickness of the molded article is preferably kept essentially constant in order to avoid flow defects. An attempt is typically made to keep the variation at less than +1-1%. However, regions such as the edge or securing elements such as clips and screw domes in a molded article often have different wall thickness. In the context of this application, therefore, the wall thickness of a molded article shall preferably be understood to mean the dominant wall thickness. The dominant wall thickness is understood to mean the wall thickness that makes up at least 70%, preferably at least 75%, more preferably at least 80%, of the area of the molded article. The wall thickness is determined on the solidified polymer melt, i.e. the finished component.

For production of the transparent molded article, preferably the light cover, more preferably the headlamp cover, especially for motor vehicles, the polycarbonate melt is preferably heated to a temperature of greater than 300 to 380° C., more preferably greater than 320° C. to 360° C., even more preferably to a temperature of 330 to 360° C., especially greater than 330° C. to 360° C. Likewise preferably, an internal mold pressure (fill pressure) of not more than 1500 bar, preferably not more than 1000 bar, is used. These parameters thus affect the achievable flow distance to wall thickness ratio. With conventional UV absorber-containing compositions used for transparent light covers, it was not possible to implement the flow distance to wall thickness ratios achievable in accordance with the invention since it was not possible to achieve components having adequate optical properties. The injection speed depends on the component to be injection-molded. The determination thereof is within the knowledge and ability of the person skilled in the art. The mold temperature is preferably 100 to 110° C.

The flow distance to wall thickness ratio is determined by determining the flow distance through the longest distance of the flow front from the center of the film gate as far as the furthest removed point reached by the flow front, and dividing this flow distance in mm by the dominant wall thickness in mm.

Molded articles made of the composition described may also be part of a multicomponent injection-molded component. This preferably means that the molded article of the invention is injection-molded onto a molded article of at least one further thermoplastic and/or is subsequently insert-molded with at least one other thermoplastic. This can also be effected in a multicomponent injection mold. The further thermoplastic(s) may be of the same or different chemical nature with respect to the thermoplastic of the molded article of the invention. In a preferred embodiment, all thermoplastics comprise the same or different polycarbonate composition(s).

According to the invention, a flow distance to wall thickness ratio of 180 to 500, preferably of 190 to 450, more preferably of 200 to 420, even more preferably of 210 to 400, additionally preferably of 250 to 390 is achieved at a wall thickness of the molded article of not more than 3 mm, preferably not more than 2.9 mm, further preferably of not more than 2.2 mm, even further preferably of not more than 1.9 mm, more preferably of not more than 1.6 mm, most preferably of not more than 1.5 mm. At the same time, the Y.I., determined to ASTM E 313-15e1 (observer: 10°/illuminant: D65) on specimen plaques having a wall thickness of 4 mm, is more preferably not more than 1.70.

The molded article, preferably the light cover, more preferably the headlamp cover, comprises the described polycarbonate-based composition. The headlamp cover has preferably been produced from the polycarbonate-based composition. This polycarbonate composition is preferably melted and is then allowed to solidify again in order to obtain the molded article. In a preferred embodiment, the molded article is obtained by injection molding.

The polycarbonate composition comprises at least one polycarbonate having a weight-average molecular weight M_{w} of 22 000 g/mol to 27 000 g/mol, preferably of 22 000 g/mol to 24 500 g/mol, determined by means of gel permeation chromatography to DIN 55672-1:2007-08, calibrated against bisphenol A polycarbonate standards using dichloromethane as eluent.

The calibration was performed with linear polycarbonates (composed of bisphenol A and phosgene) of known molar mass distribution (469 g/mol to about 100 000 g/mol) from PSS Polymer Standards Service GmbH, Germany. Method 2301-0257502-09D (2009 German language version) from Currenta GmbH & Co. OHG, Leverkusen was used for the calibration. Dichloromethane was used as eluent. The column combination in the gel permeation chromatography consisted of crosslinked styrene-divinylbenzene resins. The five analytical columns had a diameter of 7.5 mm and a length of 300 mm. The particle sizes of the column material were in the range from 3 μm to 20 μm. The concentration of the analyzed solutions was 0.2% by weight. The flow rate was adjusted to 1.0 ml/min, the temperature of the solutions was 30° C. Detection was effected using a refractive index (RI) detector.

The stated weight-average molecular weight of the polycarbonate is based on the molar mass of the polycarbonate used prior to melting. It has been found in accordance with the invention that there is no significant change in the molecular weight of the polycarbonate melts. However, it cannot be ruled out that the polycarbonate in the melt is degraded to a minor degree and hence the average molar mass is slightly reduced. However, it has been found that any degradation in the molecular weight can be essentially prevented since the relative solution viscosity ηᵣₑₗ (eta rel), measured to ISO 1628-1:2009 with an Ubbelohde viscometer in a concentration of 5 g/l in dichloromethane after a residence time of the polycarbonate composition of 10 min at 370° C., is preferably less than 1.3%, more preferably less than 1.0%, most preferably less than 0.75%, lower than the relative solution viscosity ηᵣₑₗ (eta rel) of the same sample after a residence time of the polycarbonate composition of 2 min at 320° C. Even in the melt, the polycarbonate compositions thus preferably have an essentially unchanged weight-average molecular weight.

According to the invention, the polycarbonate-based composition may also contain more than one polycarbonate. It is possible here, for example, to use a mixture of at least two polycarbonates. In this case, the polycarbonate mixture as a homogenized mixture must have the weight-average molecular weight as defined in accordance with the invention (“mean weight-average molecular weight”). The homogenization is preferably achieved here by compounding.

For the purposes of the present invention, polycarbonates are either homopolycarbonates or copolycarbonates; the polycarbonates can, as is known, be linear or branched. Preferably, the at least one polycarbonate in the polycarbonate composition is an aromatic polycarbonate.

The polycarbonates are prepared in a known manner from dihydroxyaryl compounds, carbonic acid derivatives, and optionally chain terminators and branching agents. In the case of homopolycarbonates only one dihydroxyaryl compound is used; in the case of copolycarbonates two or more dihydroxyaryl compounds are used.

Particulars pertaining to the preparation of polycarbonates are disclosed in many patent documents spanning approximately the last 40 years. Reference is made here, for example, to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate [Polycarbonates]” in Becker/Braun, Kunststoff-Handbuch [Plastics handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117-299.

Polycarbonates, preferably aromatic polycarbonates, are prepared, for example, by reaction of dihydroxyaryl compounds with carbonyl halides, preferably phosgene, and/or with dicarbonyl dihalides, preferably aromatic dicarbonyl dihalides, preferably benzenedicarbonyl dihalides, by the interfacial process, optionally with use of chain terminators and optionally with use of trifunctional or more than trifunctional branching agents. Preparation via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, 2,2-bis(4-hydroxy-3-methylphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropyl-benzene, 1,1-bis(4-hydroxyphenyl)-3,3,5-trimethylcyclohexane and 1,1-bis(4-hydroxyphenyl)-3,3,5-trimethylcyclohexane, and bisphenols (I) to (III)

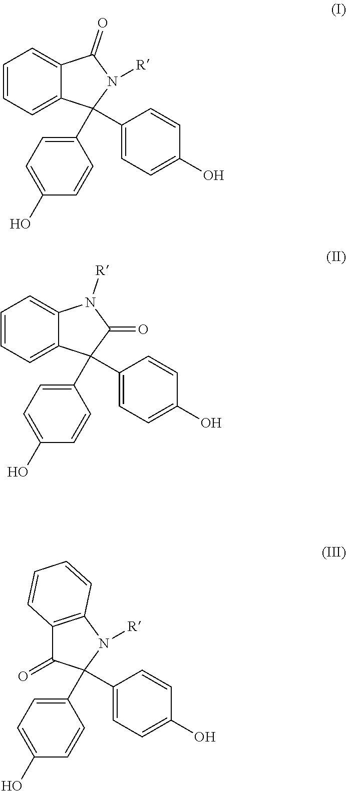

in which R′ in each case is C₁- to C₄-alkyl, aralkyl or aryl, preferably methyl or phenyl, most preferably methyl.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and 2,2-bis(4-hydroxy-3-methylphenyl)propane, and the diphenols of the formulae (I), (II) and (III).

These and other suitable dihydroxyaryl compounds are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

Examples of suitable carbonic acid derivatives include phosgene or diphenyl carbonate.

Suitable chain terminators that may be used in the preparation of the polycarbonates used in accordance with the invention are monophenols. Examples of suitable monophenols include phenol itself, alkylphenols such as cresols, p-tert-butylphenol, cumylphenol and mixtures thereof.

Preferred chain terminators are the phenols mono- or polysubstituted by linear or branched C₁- to C₃₀-alkyl radicals, preferably unsubstituted or tert-butyl-substituted. Particularly preferred chain terminators are phenol, cumylphenol and/or p-tert-butylphenol.

The amount of chain terminator to be used is preferably 0.1 to 5 mol %, further preferably 0.3 to 4 mol %, even further preferably 0.5 to 3 mol %, based on the moles of dihydroxyaryl compounds used in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional employment is preferably 0.05 mol % to 2.00 mol %, based on moles of dihydroxyaryl compounds used in each case.

The branching agents may be either initially charged together with the dihydroxyaryl compounds and the chain terminators in the aqueous alkaline phase or added dissolved in an organic solvent before the phosgenation. In the case of the transesterification process, the branching agents are used together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

According to the invention, the polycarbonate composition includes 0% to less than 0.2% by weight of a UV absorber or a UV absorber mixture, based on the total weight of the polycarbonate composition. It has been found that, surprisingly, this total content of UV absorber leads to molded articles having good optical properties. The existing prior art polycarbonate compositions that are used for covers of headlamps have a proportion of UV absorber or UV absorber mixture of at least 0.2% by weight in order to protect the polycarbonate from the lighting means of the headlamp. The molded article may either have at least one UV protection layer that likewise protects the molded article from the lighting means of the headlamp, or an LED or a laser headlamp is used as lighting means, such that no protection of the polycarbonate is necessary.

Preferably, the polycarbonate composition includes only 0% to 0.19% by weight, more preferably 0% to 0.15% by weight, even more preferably 0% to 0.10% by weight, especially preferably 0% to 0.05% by weight, of a UV absorber or a UV absorber mixture, based on the total weight of the polycarbonate composition. In a particularly preferred embodiment, the polycarbonate composition includes 0% by weight of a UV absorber or a UV absorber mixture, based on the total weight of the polycarbonate composition. 0% by weight of UV absorber or the wording “no” UV absorber should preferably be understood to mean that no UV absorber has been added deliberately to the polycarbonate composition. Traces of a UV absorber may preferably still be present, but as a result of the production process or the individual components to be used. It has been found that it is possible thereby to obtain particularly thin molded articles, preferably having a thickness of not more than 3 mm, especially those having a thickness of not more than 2.9 mm, preferably less than 2.2 mm, further preferably of less than 1.9 mm, even further preferably of less than 1.6 mm, most preferably of up to 1.5 mm, with a particularly high flow distance to wall thickness ratio as described above, with good stone-chip resistance and excellent optical properties, especially high transmittance at 400 nm. These molded articles likewise also have high transmittance over the visible region, preferably determined to ISO 13468-2:2006-07.

In a preferred embodiment, the polycarbonate composition does not include any 2-(2′-hydroxy-5′-(tert-octyl)phenyl)benzotriazole, and further preferably does not include any UV absorber.

If small amounts of UV absorber are present, these are preferably those compounds having minimum transmittance below 400 nm and maximum transmittance above 400 nm. UV absorbers particularly suitable for use in the composition of the invention are benzotriazoles, triazines, benzophenones and/or arylated cyanoacrylates.

Particularly suitable UV absorbers are preferably hydroxybenzotriazoles, such as 2-(3′,5′-bis(1,1-dimethylbenzyl)-2′-hydroxyphenyl)benzotriazole (Tinuvin® 234, BASF, Ludwigshafen), 2-(2′-hydroxy-5′-(tert-octyl)phenyl)benzotriazole (Tinuvin® 329, BASF, Ludwigshafen), bis(3-(2H-benzotriazolyl)-2-hydroxy-5-tert-octyl)methane (Tinuvin® 360, BASF, Ludwigshafen), 2-(4,6-diphenyl-1,3,5-triazin-2-yl)-5-(hexyloxy)phenol (Tinuvin® 1577, BASF, Ludwigshafen), and also benzophenones such as 2,4-dihydroxybenzophenone (Chimassorb® 22, BASF, Ludwigshafen) and 2-hydroxy-4-(octyloxy)benzophenone (Chimassorb® 81, BASF, Ludwigshafen), 2,2-bis[[(2-cyano-1-oxo-3,3-diphenyl-2-propenyl)oxy]methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (Tinuvin® 1600, BASF, Ludwigshafen), tetraethyl 2,2′-(1,4-phenylenedimethylidene)bismalonate (Hostavin® B-Cap, Clariant AG) or N-(2-ethoxyphenyl)-N′-(2-ethylphenyl)ethanediamide (Tinuvin® 312, BASF, Ludwigshafen).

Particularly preferred UV absorbers are bis(3-(2H-benzotriazolyl)-2-hydroxy-5-tertoctyl)methane (Tinuvin® 360), 2-(2′-hydroxy-5′-(tert-octyl)phenyl)benzotriazole (Tinuvin® 329) and N-(2-ethoxyphenyl)-N′-(2-ethylphenyl)ethanediamide (Tinuvin® 312), very particular preference being given to bis(3-(2H-benzotriazolyl)-2-hydroxy-5-tertoctyl)methane (Tinuvin® 360) and 2-(2′-hydroxy-5′-(tert-octyl)phenyl)benzotriazole (Tinuvin® 329).

All these UV absorbers can be used as a single component or in a mixture of at least two UV absorbers.

Preferably, the polycarbonate composition includes at least one auxiliary selected from the group consisting of a demolding agent, thermal stabilizers, antistats, pigments and/or brighteners. It is also possible here to use any desired mixtures of these auxiliaries. In addition, the polycarbonates may include transesterification stabilizers, for example triisooctyl phosphate (TOF).

In a preferred embodiment, aside from one or more of these additives, polycarbonate and any small amounts of UV absorber present, no further components are present in the composition.

Any demolding agents added are preferably selected from the group consisting of pentaerythritol tetrastearate, glycerol monostearate and long-chain fatty acid esters, for example stearyl stearate and propanediol stearate, which may not be present in pure form, preferably also at least partly esterified with other fatty acids such as palmitic acids, and mixtures thereof. The demolding agents are preferably used in amounts of 0.05% by weight to 2.00% by weight, preferably in amounts of 0.1% by weight to 1.0% by weight, more preferably in amounts of 0.15% by weight to 0.60% by weight and most preferably in amounts of 0.20% by weight to 0.50% by weight, based on the total weight of the polycarbonate composition.

Suitable thermal stabilizers are preferably triphenylphosphine, tris(2,4-di-tert-butylphenyl) phosphite (Irgafos® 168), tetrakis(2,4-di-tert-butylphenyl)-[1,1-biphenyl]-4,4′-diyl bisphosphonite, triisooctyl phosphate, octadecyl-3-(3,5-di-tert-butyl-4-hydroxyphenyl) propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36). They are used alone or in a mixture (e.g. Irganox® B900 (mixture of Irgafos® 168 and Irganox® 1076 in a 1:3 ratio) or Doverphos® S-9228 with Irganox® B900/Irganox® 1076). The thermal stabilizers are preferably used in amounts of 0.003% to 0.2% by weight, based on the total weight of the polycarbonate composition.

Antistats, pigments and brighteners and the amounts to be used are known to those skilled in the art. Compounds of this kind are described, for example, in “Plastics Additives”, R. Gächter and H. Müller, Hanser Publishers 1983.

For incorporation of additives, the at least one polycarbonate is preferably used in the form of powders, granules or mixtures of powders and granules.

The molded articles of the invention, preferably light covers, especially headlamp covers, are transparent. “Transparent” in the context of the invention means that the compositions have a visual transmission Ty (D65 observed at 10°) of at least 84%, preferably at least 87%, more preferably at least 88% and most preferably at least 89%, determined to ISO13468-2:2006 at a thickness of 4 mm, without further lacquering. More preferably, transmission is determined according to the ISO standard specified on a specimen plaque with wall thickness 4 mm and plane-parallel surfaces. Preferably, the expression “transparent” additionally means that the compositions have a haze of <5%, determined to ASTM D1003:2013 at a layer thickness of 4 mm, preferably on a specimen with wall thickness 4 mm and plane-parallel surfaces.

Preferably, the molded article of the invention has a transmittance at 400 nm, measured to ISO 13468-2 2006-07 on a 4 mm-thick flat sheet, of greater than 65%, more preferably of greater than 70%, especially preferably greater than 75% and most preferably greater than 80%. Transmittance is measured here not on the molded article itself but on a flat sheet having a thickness of 4 mm. The values reported are based on the transmittance of the uncoated molded article or of a corresponding 4 mm sheet prior to any lacquering or other coating step.

Likewise preferably, the melt of the polycarbonate composition in the production of the molded article of the invention is at a temperature of greater than 300 to 380° C., more preferably 305 to 380° C., further preferably 310 to 380° C., especially preferably 320 to 380° C., very especially preferably 325 to 370° C. and further especially preferably of 330 to 360° C., even further preferably of greater than 330 to 360° C. Such a higher temperature than the up to 300° C. utilized customarily in injection molding can also additionally have an advantageous effect with regard to avoidance of weld seams, flow marks, frozen-in stresses and other injection molding defects. According to the invention, the temperature of the polycarbonate melt is preferably understood to mean that it corresponds to the temperature which is established in the extruder. This may possibly differ from the actual temperature of the melt.

Preferably, the molded article of the invention, especially a headlamp cover, is obtained by injection molding. This preferably involves heating the melt of the polycarbonate composition to the abovementioned temperatures.

Preference is given to using an internal mold pressure (fill pressure) of not more than 1500 bar, more preferably 1000 bar, especially preferably not more than 700 bar. The preferred injection speed depends on the component to be injection-molded. The determination thereof is within the knowledge and ability of the person skilled in the art. In a preferred embodiment, the specific injection pressure is not more than 2500 bar.

More preferably, the mold temperature is constant during the production of the molded article of the invention.

In a further aspect of the invention, the molded article of the invention, at a wall thickness of not more than 5 mm, preferably has a flow distance of at least 200 mm, more preferably at least 250 mm, most preferably at least 300 mm. According to the invention, it is thus possible to produce particularly large and simultaneously thin molded articles.

More preferably, the molded article has a wall thickness of exactly or essentially 1 to 5 mm, especially preferably of exactly or essentially 1 to 3 mm, further preferably of 1.10 to 2.75 mm, further preferably of exactly or essentially 1.25 to 2.50, likewise preferably of exactly or essentially 1.5 to 2.25 and most preferably of exactly or essentially 1.5 to 2.0 mm.

According to the invention, the expression “essentially” is used more particularly in relation to the wall thickness of the molded article of the invention. This is preferably understood to mean a deviation from the value specified, for example for the wall thickness, of not greater than 25%, more preferably not greater than 10%, even more preferably not greater than 5%, especially preferably not greater than 2.5% and further preferably not greater than 1%, more preferably 0%. This value more preferably relates to the dominant wall thickness already defined above. If reference is being made to the dominant wall thickness, the deviation from the value specified is most preferably 0%.

In one aspect of the present invention, the molded article of the invention serves to cover a light source. It is further preferable here that the light source is an LED or a laser headlamp.

The headlamp covers of the invention are used for all light functions in a motor vehicle or, in particular, dipped beam, indicator or full beam. It is particularly preferable that the light is produced on the basis of light-emitting diodes (LEDs) or lasers. These headlamp covers are likewise usable in other fields of use outside the motor vehicle sector, for example floodlight covers of lights in general, but also in swimming pools etc.

Preferably, the molded article of the invention comprises at least one additional layer which is selected from the group consisting of a scratch-resistant coating, optionally with UV protection and/or an antifog coating. This molded article of the invention may also have a plurality of each of these layers.

Scratch-resistant layers, optionally with UV protection, are known to those skilled in the art. These can be applied to the molded article by known methods such as flow coating, spraying or dipping. The scratch-resistant lacquers and application thereof are described, for example, in DE10018935 A1, EP1164005A1, EP1089863 A1, EP0779327 A1, DE69317237 T2, EP1995056 A1, DE69105538 T2.

Antifog lacquers, also specifically on polycarbonate substrates, are likewise known to the person skilled in the art and have been described many times in the literature, for example in EP 1633805A1, U.S. Pat. Nos. 6,780,516B2, 5,877,254A, and 4,604,425A.

In a further aspect of the present invention, a process for producing a transparent molded article, preferably a light cover, especially a headlamp cover, is provided, comprising the steps of:

(i) providing a composition based on aromatic polycarbonate, comprising
a) aromatic polycarbonate, where the polycarbonate has a mean weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, and where the polycarbonate includes 0 to 19 mol % of carbonate units of the formula (1)

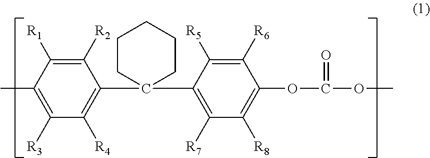

where R₁, R₂, R₃, R₄, R₅, R₆, R₇ and R₈ are independently H or C₁- to C₆-alkyl, and is preferably free of carbonate units of the formula (1), and
b) 0% to less than 0.2% by weight of a UV absorber or a UV absorber mixture, based on the total weight of the polycarbonate composition,
(ii) forming a molded article, preferably a light cover, especially a headlamp cover, by injection molding of the molten polycarbonate composition from step (i), where the melt of the polycarbonate composition is at a temperature of greater than 300 to 380° C., preferably of 330 to 360° C.

The process of the invention preferably produces the molded article of the invention, especially a headlamp of the invention, in all configurations and preferences. All the above-described preferred variants are also applicable to the individual steps (i) and (ii) of the process of the invention.

In a preferred embodiment, the process of the invention additionally includes the following step:

(iii) applying at least one layer to the molded article from step (ii), where the at least one layer is selected from the group consisting of a scratch-resistant coating, optionally with UV protection, and an antifog coating. In the case of a headlamp cover, preference is given to applying a scratch-resistant coating with UV-protective action to the outside of the headlamp cover and an antifog lacquer to the inside of the headlamp cover.

It has been found that, by means of the basic concept of the invention, thin molded articles having good mechanical and optical properties are obtained. It is possible here to produce, in particular, thin molded articles, preferably light covers, especially headlamp covers, since the melt of the polycarbonate composition in step (ii) of the process of the invention is at a temperature of greater than 300 to 380° C., more preferably 305 to 380° C., further preferably 310 to 380° C., especially preferably 320 to 380° C., very especially preferably 325 to 370° C. and further especially preferably of 330 to 360° C., extremely preferably greater than 330 to 360° C.

### EXAMPLES

### Materials Used:

Material M1: linear bisphenol A polycarbonate, containing demolding agent, with an MVR (300° C./1.2 kg) of 19 cm³/10 min and a molecular weight Mₙ, of about 24 000 g/mol and Mₙ of about 10 000 g/mol from Covestro Deutschland AG

Material M2: linear bisphenol A polycarbonate, containing demolding agent, with an MVR (300° C./1.2 kg) of 19 cm³/10 min and a molecular weight Mₙ, of about 24 000 g/mol and Mₙ of about 10 000 g/mol from Covestro Deutschland AG

Comparative material V1: a linear bisphenol A polycarbonate that has been stabilized with 0.2% by weight of 2-(2′-hydroxy-5′-(tert-octyl)phenyl)benzotriazole, containing demolding agent, with an MVR (300° C./1.2 kg) of 19 cm³/10 min and a molecular weight M_{w} of about 24 000 g/mol and Mₙ of about 10 000 g/mol from Covestro Deutschland AG

Melt volume flow rate (MVR) was determined in accordance with ISO 1133-1:2011 (at a test temperature of 300° C., mass 1.2 kg) using a Zwick 4106 instrument from Zwick Roell. The abbreviation MVR stands for the initial melt volume flow rate (after a preheating time of 7 minutes), the abbreviation IMVR20′ for the melt volume flow rate after 20 min, and the abbreviation IMVR30′ for the melt volume flow rate after 30 min.

Relative solution viscosity “ηᵣₑₗ (eta rel)” was determined by double determination to ISO1628-1:2009 with an Ubbelohde viscometer in a concentration of 5 g/l in dichloromethane. The figures reported hereinafter are always the average values of relative solution viscosity.

The optical data were measured in accordance with the standard measurement standard ISO 13468-2:2006-07. More particularly, transmittance was measured at 400 nm to ISO 13468-2:2006-07 on a 4 mm-thick flat sheet.

Yellowness index (Y.I.) was determined according to ASTM E 313-15e1 (observer: 10°/illuminant: D65) on specimen plaques having a wall thickness of 4 mm.

Transmittance in the visible region (Ty) was determined to ISO 13468-2:2006-07 on specimen plaques having a wall thickness of 4 mm.

Color locus was determined according to ASTM E 308-15 on specimen plaques having a wall thickness of 4 mm.

All specimen plaques were flat sheets.

Molecular weight M_{w} and Mₙ of the polycarbonate used was determined by means of gel permeation chromatography using a polycarbonate calibration (method from Currenta GmbH & Co. OHG, Leverkusen: PSS SECcurity System; dichloromethane as eluent, column 1 (PL-PC5) with a concentration of 2 g/l, flow rate 1.0 ml/min at a temperature of 30° C. using RI detection), method as described in the general description.

### Example 1

60 mm×40 mm×4 mm specimen plaques were injection-molded under various conditions and the optical properties and molecular weight using the relative solution viscosity were determined. The mold temperature in each case was 90° C. The changes were each calculated relative to the corresponding plaques at 320° C. and normal (“single”) residence time (identified by “Ref”). The residence time is 2 min for regular (“single”) residence time and 10 min for the 5× residence time.

TABLE 1
Comparison of ηᵣₑₗ and the optical properties of M1 and V1

| | Melt | | | | Color change | Change in YI | Transmittance | Delta |
|---|---|---|---|---|---|---|---|---|
| Material | temperature | Residence time | ηᵣₑₗ | Delta ηᵣₑₗ | delta b | Yellowness | Ty [%] | transmittance |
| M1 | 320° C. | 1x | 1.257 | 0 (Ref) | 0 (Ref) | 0 (Ref) | 88.76 | 0 (Ref) |
| | | 3x | 1.255 | −0.002 | 0.22 | 0.39 | 88.72 | −0.05 |
| | | 5x | 1.255 | −0.002 | 0.06 | 0.10 | 88.75 | −0.02 |
| | 340° C. | 1x | 1.256 | −0.001 | 0.21 | 0.37 | 88.71 | −0.06 |
| | | 3x | 1.254 | −0.003 | 0.24 | 0.42 | 88.66 | −0.10 |
| | | 5x | 1.251 | −0.006 | 0.30 | 0.53 | 88.65 | −0.11 |
| | 360° C. | 1x | 1.256 | −0.001 | 0.14 | 0.25 | 88.75 | −0.01 |
| | | 3x | 1.252 | −0.005 | 0.26 | 0.46 | 88.69 | −0.08 |
| | | 5x | 1.251 | −0.006 | 0.38 | 0.68 | 88.66 | −0.10 |
| | 370° C. | 1x | 1.254 | −0.003 | 0.19 | 0.35 | 88.70 | −0.07 |
| | | 3x | 1.252 | −0.005 | 0.34 | 0.60 | 88.69 | −0.07 |
| | | 5x | 1.250 | −0.007 | 0.66 | 1.19 | 87.39 | −1.37 |
| V1 | 320° C. | 1x | 1.256 | 0 (Ref) | 0 (Ref) | 0 (Ref) | 87.70 | 0 (Ref) |
| | | 3x | 1.255 | −0.001 | 0.04 | 0.05 | 87.53 | −0.16 |
| | | 5x | 1.253 | −0.003 | −0.06 | −0.12 | 87.65 | −0.04 |
| | 340° C. | 1x | 1.254 | −0.002 | −0.05 | −0.10 | 87.71 | 0.01 |
| | | 3x | 1.251 | −0.005 | 0.01 | −0.00 | 87.60 | −0.10 |
| | | 5x | 1.245 | −0.011 | 0.17 | 0.33 | 85.12 | −2.58 |
| | 360° C. | 1x | 1.253 | −0.003 | −0.08 | −0.16 | 87.69 | −0.01 |
| | | 3x | 1.248 | −0.008 | 0.09 | 0.17 | 87.54 | −0.16 |
| | | 5x | 1.243 | −0.013 | −0.02 | 0.01 | 87.69 | −0.01 |
| | 370° C. | 1x | 1.250 | −0.006 | 0.04 | 0.06 | 87.69 | −0.00 |
| | | 3x | 1.244 | −0.012 | 0.05 | 0.15 | 87.64 | −0.05 |
| | | 5x | 1.238 | −0.018 | 0.31 | 0.65 | 86.80 | −0.90 |

The polycarbonate material M1 shows little degradation, apparent from Tim, particularly at elevated temperatures and longer residence time, compared to V1.

### Example 2: Measurement of MVR with Prolonged Service Life as Well (to ISO 1133-1:2011)

TABLE 2
Comparison of MVR after prolonged service life for M1 and V1

| | | | Delta (5 min | | Delta (5 min |
|---|---|---|---|---|---|
| | Test | Material V1 | vs. | Material M1 | vs. |
| | conditions | MVR | 20 min) | MVR | 20 min) |
| 5 min. | 320° C./1.2 kg | 32.5 cm³/(10 min) | | 33.1 cm³/(10 min) | |
| 20 min. | 320° C./1.2 kg | 34.7 cm³/(10 min) | 6.8% | 32.5 cm³/(10 min) | −1.8% |
| 5 min. | 340° C./2.16 kg | 54.5 cm³/(10 min) | | 52.5 cm³/(10 min) | |
| 20 min. | 340° C./2.16 kg | 63.1 cm³/(10 min) | 15.8% | 52.3 cm³/(10 min) | −0.4% |

Material M1, at higher temperatures, shows less change in MVR measured after 5 min compared to measurement after 20 min. This means a distinct improvement in melt stability particularly at elevated temperatures compared to V1.

### Example 3

The flowability of materials M1 and M2 was demonstrated using a plaque mold. The plaque had the dimensions of length 1000 mm, width 250 mm and wall thickness 2 mm. On the long side there was a film gate of width 125 mm. The flow length was determined from the feed point to the end of the flow front (furthest removed point), likewise on the long plaque side.

An Engel Duo 1500 injection molding machine was used. The pellets were dried at 120° C. for 4 hours. The holding force was 15 0001N, the screw had D=90 mm and the mold temperature was 100° C. At an injection speed of 60 mm/s, the injection operation was stopped until attainment of the injection pressure limit of 2000 bar (specific) at the end of the flow distance.

TABLE 3
Determination of the flow distance to wall thickness ratio for
M1 and M2

| | Melt temperature | Flow distance | Flow distance to wall |
|---|---|---|---|
| Material | [° C.] | [mm] | thickness ratio |
| M1 | 340 | 637 | 318.5 |
| | 350 | 687 | 343.5 |
| | 360 | 748 | 374 |
| M2 | 340 | 570 | 285 |
| | 350 | 672 | 336 |
| | 360 | 711 | 355.5 |

The polycarbonates have high flow distance to wall thickness ratios. All the plaques obtained show good optical properties.

It can be shown by this experiment that, in inventive examples 1 and 2, polycarbonate compositions that have the flow distance to wall thickness ratio defined in accordance with the invention at a wall thickness of up to 3 mm were used. This also makes it clear that components that are produced from the polycarbonate compositions M1 and M2 are in accordance with the invention (even though they have an actual wall thickness of 4 mm in examples 1 and 2).

### Example 4

### Components:

PC-1: linear polycarbonate based on bisphenol A having a melt volume flow rate MVR of 19 cm³/10 min (to ISO 1133-1:2011, at a test temperature of 300° C. with a load of 1.2 kg)

PC-2: powder of a linear polycarbonate based on bisphenol A having a melt volume flow rate MVR of 19 cm³/10 min (to ISO 1133-1:2011 at a test temperature of 300° C. with a load of 1.2 kg)

PC-3: linear polycarbonate based on bisphenol A having a melt volume flow rate MVR of 27 cm³/10 min (to ISO 1133-1:2011, at a test temperature of 300° C. with a load of 1.2 kg)

PC-4: linear polycarbonate based on bisphenol A having a melt volume flow rate MVR of 19 cm³/10 min (to ISO 1133-1:2011, at a test temperature of 300° C. with a load of 1.2 kg), a molecular weight M_{w} of about 23 900 g/mol and Mₙ of about 9900 g/mol and tert-butylphenol as chain terminator

PC-5: linear polycarbonate based on bisphenol A having a melt volume flow rate MVR of 19 cm³/10 min (to ISO 1133-1:2011, at a test temperature of 300° C. with a load of 1.2 kg), a molecular weight M_{w} of about 23 930 g/mol and Mₙ of about 10 280 g/mol and tert-butylphenol as chain terminator

A1: pentaerythritol tetrastearate (Emery Oleochemicals, Loxstedt)

A2: 2-(2′-hydroxy-5′-(tert-octyl)phenyl)benzotriazole (Tinuvin® 329, BASF, Ludwigshafen)

A3: triphenylphosphine (BASF, Ludwigshafen)

A4: tris(2,4-di-tert-butylphenyl)phosphite (Irgafos® 168) (BASF, Ludwigshafen),

A5: Irganox® B900 (mixture of Irgafos® 168 and Irganox® 1076 in a ratio of 80:20) (Irganox® 1076=octadecyl 3-(3,5-di-tert-butyl-4-hydroxyphenyl)propionate) (BASF, Ludwigshafen)

A6: 2,2′-methylenebis[6-(2H-benzotriazol-2-yl)-4-(1,1,3,3-tetramethylbutyl)phenol] (Tinuvin 360, BASF, Ludwigshafen)

A7: 2-(2H-benzotriazol-2-yl)-4,6-bis(1-methyl-1-phenylethyl) (Tinuvin 234, BASF, Ludwigshafen)

A8: triisooctylphenol (TOF, Lanxess AG; Germany)

The compounds of the invention for the examples which follow were produced in a Berstorff ZE 25 extruder with a throughput of 5 kg/h and a speed of 50/min and a temperature of 275° C.

Compositions M3 to M10 can be shaped to molded articles having a flow distance to wall thickness ratio at a theoretical maximum wall thickness of essentially 3 mm of greater than 180. It is thus possible to use compositions M3 to M10 to produce molded articles of the invention. What are examined hereinafter, however, are sheets of thickness 4 mm since this is the standard wall thickness for measurement of optical properties.

The abbreviation RT stands for residence time. The residence time is 2 min for regular (“single”) residence time and 10 min for the 5× residence time.

TABLE 4
Results from the measurement of compounds M3 and M4, and V2 to V5

| Composition/sample | | M3 | M4 | V2 | V3 | V4 | V5 |
|---|---|---|---|---|---|---|---|
| PC-1 | % by wt. | 95 | 95 | 95 | 95 | 95 | 95 |
| PC-2 | % by wt. | 4.78 | 4.58 | 4.58 | 4.38 | 4.48 | 4.28 |
| A1 | % by wt. | 0.2 | 0.4 | 0.2 | 0.4 | 0.2 | 0.4 |
| A2 | % by wt. | — | — | 0.2 | 0.2 | 0.3 | 0.3 |
| A3 | % by wt. | 0.02 | 0.02 | 0.02 | 0.02 | 0.02 | 0.02 |
| Properties measured | | | | | | | |
| Molecular weight Mₙ | g/mol | 9591 | 9812 | 9663 | 9710 | 9218 | 9748 |
| Molecular weight M_{w} | g/mol | 23096 | 23276 | 23292 | 23375 | 23268 | 23467 |
| ηᵣₑₗ | | 1.251 | 1.250 | 1.251 | 1.250 | 1.251 | 1.250 |
| MVR 300° C./1.2 kg | ml/(10 min) | 19.7 | 20.2 | 20.8 | 21.3 | 21.1 | 21.8 |
| IMVR20′ 300° C./1.2 kg | ml/(10 min) | 20.7 | 21.3 | 21.8 | 22.7 | 22.2 | 23.1 |
| IMVR30′ 300° C./1.2 kg | ml/(10 min) | 20.9 | 21.8 | 22.0 | 23.7 | 22.5 | 23.3 |
| Delta MVR/IMVR20′ | | 1.0 | 1.1 | 1.0 | 1.4 | 1.1 | 1.3 |
| 300° C./1.2 kg | | | | | | | |
| Delta MVR/IMVR30′ | | 1.2 | 1.6 | 1.2 | 2.4 | 1.4 | 1.5 |
| 300° C./1.2 kg | | | | | | | |
| MVR 320° C./1.2 kg | ml/(10 min) | 35.5 | 36.6 | 36.2 | 37.5 | 37.8 | 37.7 |
| IMVR20′ 320° C./1.2 kg | ml/(10 min) | 35.5 | 36.8 | 37.6 | 39.9 | 39.6 | 41.6 |
| IMVR30′ 320° C./1.2 kg | ml/(10 min) | 35.2 | 37.1 | 40.7 | 42.9 | 43.2 | 45.5 |
| Delta MVR/IMVR20′ | | 0.0 | 0.2 | 1.4 | 2.4 | 1.8 | 3.9 |
| 320° C./1.2 kg | | | | | | | |
| Delta MVR/IMVR30′ | | −0.3 | 0.5 | 4.5 | 5.4 | 5.4 | 7.8 |
| 320° C./1.2 kg | | | | | | | |
| Optical properties of 4 mm | | | | | | | |
| plaques | | | | | | | |
| 300° C. | | | | | | | |
| Transmittance at 380 nm | % | 83.82 | 84.35 | 2.81 | 2.75 | 2.49 | 2.55 |
| Transmittance at 400 nm | % | 86.83 | 87.35 | 58.25 | 56.65 | 48.72 | 48.00 |
| Y.I. | | 1.39 | 1.22 | 1.73 | 1.71 | 1.88 | 2.03 |
| 300° C. 5x RT | | | | | | | |
| Transmittance at 380 nm | % | 83.15 | 83.74 | 2.89 | 2.69 | 2.55 | 2.53 |
| Transmittance at 400 nm | % | 86.55 | 87.10 | 58.23 | 56.66 | 48.37 | 47.98 |
| Y.I. | | 1.47 | 1.32 | 1.81 | 1.82 | 1.99 | 2.09 |
| 320° C. | | | | | | | |
| Transmittance at 380 nm | % | 83.05 | 83.38 | 2.92 | 2.76 | 2.47 | 2.50 |
| Transmittance at 400 nm | % | 86.63 | 86.99 | 58.03 | 56.45 | 48.37 | 47.93 |
| Y.I. | | 1.51 | 1.37 | 1.88 | 1.84 | 2.00 | 2.15 |
| 320° C. 5x RT | | | | | | | |
| Transmittance at 380 nm | % | 82.70 | 82.85 | 3.01 | 2.76 | 2.43 | 2.63 |
| Transmittance at 400 nm | % | 86.20 | 86.62 | 57.88 | 56.47 | 48.56 | 47.82 |
| Y.I. | | 1.52 | 1.46 | 1.95 | 1.90 | 2.12 | 2.22 |

TABLE 5
Results from the measurement of compounds M5 and M6, and V6 to V13

| Composition/sample | | M5 | M6 | V6 | V7 | V8 | V9 | M7 |
|---|---|---|---|---|---|---|---|---|
| PC-1 | % by wt. | 95 | 95 | 95 | 95 | 95 | 95 | 95 |
| PC-2 | % by wt. | 4.77 | 4.57 | 4.57 | 4.37 | 4.47 | 4.27 | 4.77 |
| A1 | % by wt. | 0.2 | 0.4 | 0.2 | 0.4 | 0.2 | 0.4 | 0.2 |
| A2 | % by wt. | — | — | 0.2 | 0.2 | 0.3 | 0.3 | — |
| A4 | % by wt. | 0.03 | 0.03 | 0.03 | 0.03 | 0.03 | 0.03 | — |
| A5 | % by wt. | — | — | — | — | — | — | 0.03 |
| Molecular weight Mₙ | g/mol | 9432 | 9247 | 9499 | 9167 | 9484 | 9462 | 9381 |
| Molecular weight M_{w} | g/mol | 23340 | 23239 | 23365 | 23297 | 23334 | 23390 | 23443 |
| ηᵣₑₗ granulates | | 1.256 | 1.254 | 1.251 | 1.253 | 1.255 | 1.253 | 1.256 |
| MVR 300° C./1.2 kg | ml/(10 min) | 19.0 | 19.0 | 18.8 | 19.7 | 18.5 | 19.6 | 18.7 |
| IMVR20′ 300° | ml/(10 min) | 18.7 | 19.1 | 18.5 | 19.7 | 19.1 | 20.3 | 16.1 |
| C./1.2 kg | | | | | | | | |
| IMVR30′ 300° | ml/(10 min) | 19.0 | 19.5 | 19.5 | 20.4 | 19.9 | 20.4 | 18.9 |
| C./1.2 kg | | | | | | | | |
| Delta MVR/IMVR20′ | | −0.3 | 0.1 | −0.3 | 0.0 | 0.6 | 0.7 | −2.6 |
| 300° C./1.2 kg | | | | | | | | |
| Delta MVR/IMVR30′ | | 0.0 | 0.5 | 0.7 | 0.7 | 1.4 | 0.8 | 0.2 |
| 300° C./1.2 kg | | | | | | | | |
| MVR 320° C./1.2 kg | ml/(10 min) | 32.8 | 33.9 | 33.5 | 34.1 | 33.1 | 34.2 | 32.1 |
| IMVR20′ 320° | ml/(10 min) | 34.1 | 33.6 | 34.0 | 36.4 | 34.7 | 35.3 | 32.8 |
| C./1.2 kg | | | | | | | | |
| IMVR30′ 320° | ml/(10 min) | 34.3 | 34.4 | 35.4 | 36.5 | 36.4 | 36.1 | 33.9 |
| C./1.2 kg | | | | | | | | |
| Delta MVR/IMVR20′ | | 1.3 | −0.3 | 0.5 | 2.3 | 1.6 | 1.1 | 0.7 |
| 320° C./1.2 kg | | | | | | | | |
| Delta MVR/IMVR30′ | | 1.5 | 0.5 | 1.9 | 2.4 | 3.3 | 1.9 | 1.8 |
| 320° C./1.2 kg | | | | | | | | |
| Optical data processing | | | | | | | | |
| stability 4 mm | | | | | | | | |
| 300° C. | | | | | | | | |
| Transmission Ty | % | 89.55 | 89.6 | 89.6 | 89.58 | 89.55 | 89.55 | 89.56 |
| Yellowness index | | 2.16 | 1.98 | 2.38 | 2.39 | 3.04 | 2.12 | 2.9 |
| Haze | % | 0.27 | 0.25 | 0.25 | 0.37 | 0.26 | 0.22 | 0.33 |
| 300° C. 5xRT | | | | | | | | |
| Transmittance Ty | % | 89.45 | 89.56 | 89.56 | 89.55 | 89.62 | 89.68 | 89.49 |
| Yellowness index | | 2.36 | 1.78 | 2.51 | 2.59 | 2.56 | 1.67 | 3.17 |
| Haze | % | 0.26 | 0.37 | 0.26 | 0.27 | 0.24 | 0.23 | 0.3 |
| 320° C. | | | | | | | | |
| Transmittance Ty | % | 89.33 | 89.48 | 89.46 | 89.45 | 89.46 | 89.42 | 89.37 |
| Yellowness index | | 2.81 | 2.4 | 2.89 | 2.83 | 3.23 | 2.55 | 3.26 |
| Haze | % | 0.24 | 0.32 | 0.23 | 0.28 | 0.45 | 0.27 | 0.34 |
| 320° C. 5xRT | | | | | | | | |
| Transmittance Ty | % | 87.00 | 89.53 | 87.77 | 86.43 | 89.17 | 89.36 | 89.32 |
| Yellowness index | | 2.8 | 2.01 | 2.87 | 2.84 | 3.43 | 2.54 | 3.12 |
| Haze | % | 6.83 | 0.26 | 6.61 | 7.34 | 0.78 | 1.41 | 1.71 |

| Composition/sample | | M8 | V10 | V11 | V12 | V13 |
|---|---|---|---|---|---|---|
| PC-1 | % by wt. | 95 | 95 | 95 | 95 | 95 |
| PC-2 | % by wt. | 4.57 | 4.57 | 4.37 | 4.47 | 4.27 |
| A1 | % by wt. | 0.4 | 0.2 | 0.4 | 0.2 | 0.4 |
| A2 | % by wt. | — | 0.2 | 0.2 | 0.3 | 0.3 |
| A4 | % by wt. | — | — | — | — | — |
| A5 | % by wt. | 0.03 | 0.03 | 0.03 | 0.03 | 0.03 |
| Molecular weight Mₙ | g/mol | 9570 | 9715 | 9614 | 9710 | 9639 |
| Molecular weight M_{w} | g/mol | 23429 | 23519 | 23508 | 23740 | 23476 |
| ηᵣₑₗ granulates | | 1.255 | 1.253 | 1.254 | 1.254 | 1.253 |
| MVR 300° C./1.2 kg | ml/(10 min) | 18.1 | 19.4 | 18.9 | 19.3 | 20.0 |
| IMVR20′ 300° | ml/(10 min) | 18.0 | 20.1 | 19.1 | 19.7 | 20.7 |
| C./1.2 kg | | | | | | |
| IMVR30′ 300° | ml/(10 min) | 18.3 | 20.4 | 19.4 | 19.4 | 19.8 |
| C./1.2 kg | | | | | | |
| Delta MVR/IMVR20′ | | −0.1 | 0.7 | 0.2 | 0.4 | 0.7 |
| 300° C./1.2 kg | | | | | | |
| Delta MVR/IMVR30′ | | 0.2 | 1.0 | 0.5 | 0.1 | −0.2 |
| 300° C./1.2 kg | | | | | | |
| MVR 320° C./1.2 kg | ml/(10 min) | 31.0 | 33.2 | 32.7 | 33.3 | 35.1 |
| IMVR20′ 320° | ml/(10 min) | 31.7 | 36.2 | 34.6 | 35.2 | 36.5 |
| C./1.2 kg | | | | | | |
| IMVR30′ 320° | ml/(10 min) | 31.6 | 35.2 | 34.4 | 37.1 | 37.1 |
| C./1.2 kg | | | | | | |
| Delta MVR/IMVR20′ | | 0.7 | 3.0 | 1.9 | 1.9 | 1.4 |
| 320° C./1.2 kg | | | | | | |
| Delta MVR/IMVR30′ | | 0.6 | 2.0 | 1.7 | 3.8 | 2.0 |
| 320° C./1.2 kg | | | | | | |
| Optical data processing | | | | | | |
| stability 4 mm | | | | | | |
| 300° C. | | | | | | |
| Transmission Ty | % | 89.58 | 89.6 | 89.63 | 89.66 | 89.58 |
| Yellowness index | | 2.07 | 2.22 | 2.33 | 2.36 | 2.48 |
| Haze | % | 0.25 | 0.28 | 0.23 | 0.25 | 0.23 |
| 300° C. 5xRT | | | | | | |
| Transmittance Ty | % | 89.52 | 89.58 | 89.63 | 89.63 | 89.65 |
| Yellowness index | | 2.09 | 2.37 | 2.16 | 2.35 | 2.23 |
| Haze | % | 0.28 | 0.33 | 0.3 | 0.26 | 0.28 |
| 320° C. | | | | | | |
| Transmittance Ty | % | 88.98 | 89.54 | 89.5 | 89.5 | 89.56 |
| Yellowness index | | 2.54 | 2.5 | 2.6 | 2.94 | 2.62 |
| Haze | % | 0.45 | 0.29 | 0.34 | 0.52 | 0.31 |
| 320° C. 5xRT | | | | | | |
| Transmittance Ty | % | 89.32 | 89.52 | 89.54 | 86.99 | 89.58 |
| Yellowness index | | 2.52 | 2.37 | 2.32 | 2.7 | 2.36 |
| Haze | % | 0.67 | 2.44 | 0.65 | 2.73 | 0.36 |

TABLE 6
Results from the measurement of compounds M9 and M10, and V14 to V17

| Recipe | | M9 | M10 | V14 | V15 | V16 | V17 |
|---|---|---|---|---|---|---|---|
| PC-3 | % by wt. | 95 | 95 | 95 | 95 | 95 | 95 |
| PC-2 | % by wt. | 4.78 | 4.58 | 4.58 | 4.38 | 4.48 | 4.28 |
| A1 | % by wt. | 0.2 | 0.4 | 0.2 | 0.4 | 0.2 | 0.4 |
| A2 | % by wt. | — | — | 0.2 | 0.2 | 0.3 | 0.3 |
| A3 | % by wt. | 0.02 | 0.02 | 0.02 | 0.02 | 0.02 | 0.02 |
| Tests: | | | | | | | |
| etaᵣₑₗ | | 1.241 | 1.239 | 1.240 | 1.238 | 1.239 | 1.239 |
| Mₙ | g/mol | 9488 | 9527 | 9686 | 9594 | 9794 | 9585 |
| M_{w} | g/mol | 22336 | 22093 | 22368 | 21800 | 22607 | 22406 |
| MVR 300° C./1.2 kg | ml/(10 min) | 25.7 | 26.7 | 26.7 | 27.9 | 27.4 | 28.4 |
| IMVR20′ 300° C./1.2 kg | ml/(10 min) | 25.8 | 27.5 | 27.5 | 29.0 | 28.9 | 31.1 |
| IMVR30′ 300° C./1.2 kg | ml/(10 min) | 26.0 | 27.8 | 28.6 | 30.5 | 31.8 | 33.0 |
| Delta MVR/IMVR20′ | | 0.1 | 0.8 | 0.8 | 1.1 | 1.5 | 2.7 |
| Delta MVR/IMVR30′ | | 0.3 | 1.1 | 1.9 | 2.6 | 4.4 | 4.6 |
| MVR 320° C./1.2 kg | ml/(10 min) | 47.8 | 49.1 | 49.2 | 50.8 | 49.3 | 52.0 |
| IMVR20′ 320° C./1.2 kg | ml/(10 min) | 46.0 | 49.4 | 54.2 | 57.6 | 55.7 | 62.1 |
| IMVR30′ 320° C./1.2 kg | ml/(10 min) | 46.6 | 49.5 | 55.5 | 59.8 | 59.4 | 62.5 |
| Delta MVR/IMVR20′ | | −1.8 | 0.3 | 5.0 | 6.8 | 6.4 | 10.1 |
| Delta MVR/IMVR30′ | | −1.2 | 0.4 | 6.3 | 9.0 | 10.1 | 10.5 |
| Optical properties 4 | | | | | | | |
| 300° C. | | | | | | | |
| Transmittance Ty | % | 89.69 | 89.70 | 89.72 | 89.69 | 89.70 | 89.76 |
| Haze | % | 0.25 | 0.21 | 0.18 | 0.16 | 0.15 | 0.16 |
| Y.I. | | 1.62 | 1.68 | 2.04 | 2.08 | 2.25 | 2.23 |
| 300° C. 5x RT | | | | | | | |
| Transmittance Ty | % | 89.70 | 89.71 | 89.70 | 89.70 | 89.70 | 89.77 |
| Haze | % | 0.24 | 0.20 | 0.19 | 0.19 | 0.18 | 0.19 |
| Y.I. | | 1.59 | 1.64 | 2.11 | 2.15 | 2.33 | 2.32 |
| 320° C. | | | | | | | |
| Transmittance Ty | % | 89.63 | 89.73 | 89.67 | 89.71 | 89.58 | 89.73 |
| Haze | % | 0.30 | 0.17 | 0.21 | 0.17 | 0.17 | 0.20 |
| Y.I. | | 1.63 | 1.60 | 2.22 | 2.22 | 2.48 | 2.34 |
| 320° C. 5x RT | | | | | | | |
| Transmittance Ty | % | 89.67 | 89.74 | 89.66 | 89.43 | 89.69 | 89.73 |
| Haze | % | 0.35 | 0.21 | 0.00 | 0.82 | 0.26 | 0.25 |
| Y.I. | | 1.62 | 1.58 | 2.20 | 2.29 | 2.47 | 2.42 |

TABLE 7
Results from the measurement of compounds M11 and M12

| | | M11 | M12 |
|---|---|---|---|
| Recipe | | | |
| PC-4 | % by wt. | 99.73 | |
| PC-5 | % by wt. | | 99.68 |
| A1 | % by wt. | 0.14 | 0.19 |
| A5 | % by wt. | 0.026 | 0.032 |
| A6 | % by wt. | 0.09 | |
| A7 | % by wt. | | 0.09 |
| A8 | % by wt. | 0.01 | 0.01 |
| Tests: | | | |
| Optical properties | | | |
| 280° C./1x RT | | | |
| Transmittance Ty | % | 88.61 | 88.20 |
| Y.I. | | 0.68 | 1.03 |
| Haze | % | 0.22 | 0.38 |
| 320° C./1x RT | | | |
| Transmittance Ty | % | 88.60 | 88.33 |
| Y.I. | | 0.78 | 0.82 |
| Haze | % | 0.22 | 0.18 |
| 320° C./3x RT | | | |
| Transmittance Ty | % | 88.54 | 88.19 |
| Y.I. | | 1.00 | 1.11 |
| Haze | % | 0.43 | 0.23 |
| 320° C./5x RT | | | |
| Transmittance Ty | % | 88.15 | 88.12 |
| Y.I. | | 1.19 | 1.33 |
| Haze | % | 2.08 | 0.29 |
| 350° C./1x RT | | | |
| Transmittance Ty | % | 87.83 | 87.08 |
| Y.I. | | 0.85 | 2.69 |
| Haze | % | 1.06 | 0.48 |
| 350° C./3x RT | | | |
| Transmittance Ty | % | — | 88.30 |
| Y.I. | | — | 0.81 |
| Haze | % | — | 0.49 |
| 350° C./5x RT | | | |
| Transmittance Ty | % | — | 88.30 |
| Y.I. | | — | 1.07 |
| Haze | % | — | 0.50 |

RT: residence time in the injection molding machine

The polycarbonates of examples M3-M10, at elevated temperatures and with prolonged service life, show improved melt stability compared to comparative examples V2-V17. Optical properties are constant at a very good level for all materials of the invention.

### Example 5: Simulation of Flowability Under Standard Conditions

A cuboidal strip was simulated with an end face of 25 mm by a variable wall thickness of 1.5 to 4 mm. There was also assumed to be a film gate on one of the two end sides. The length of the strip was 1156 mm. The mold temperature was assumed to be 100° C., the fill pressure to be 1000 bar and the melt temperature to be 300° C. Higher temperatures in the case of material V1 lead to a considerable deterioration in the optical properties of the molded article obtained and are therefore unusable. In the simulation with the commercially available Autodesk® Moldflow® Version AMI2016 SP3 software, this mold was filled with V1. The flow distances are compiled in table 7.

TABLE 8
Simulated flowability of comparative material V1

| | | | | | | |
|---|---|---|---|---|---|---|
| Wall thickness | 1.5 | 1.8 | 2.0 | 2.2 | 3 | 4 |
| in mm | | | | | | |
| Flow distance | 150 | 202 | 242 | 285 | 478 | 755 |
| in mm by | | | | | | |
| simulation | | | | | | |
| Ratio of flow | 100 | 112 | 121 | 130 | 159 | 189 |
| distance to | | | | | | |
| wall thickness | | | | | | |

As can be inferred from the results in table 7, in the case of comparative composition V1, the flow distance to wall thickness ratio at a wall thickness of 3 mm is limited to a value below the range of the invention. Accordingly, the flow distance to wall thickness ratios for thinner molded articles are still well below the range of the invention.

1. A process for producing a transparent molded article, comprising injection molding a polycarbonate-based composition A,
comprising
a) aromatic polycarbonate, where the polycarbonate has a mean weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, and where the polycarbonate includes 0 to not more than 19 mol % of carbonate units of the formula (1) 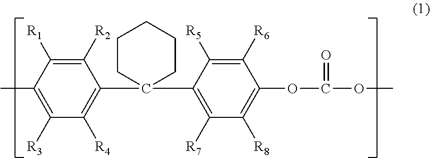
where R₁, R₂, R₃, R₄, R₅, R₆, R₇ and R₈ are independently H or C₁- to C₆-alkyl,
and
b) 0% to less than 0.2% by weight of a UV absorber or a UV absorber mixture, based on the total weight of the polycarbonate composition.

2. The process of claim 1, wherein the transparent molded article has a flow distance to wall thickness ratio of 180 to 500.

3. The process of claim 1, wherein the molded article has a transmittance at 400 nm, measured to ISO 13468-2:2006-07 on a 4 mm-thick flat sheet, of greater than 65%.

4. The process of claim 1, wherein the composition A consists of components a) and b), and
c) one or more additives selected from the group consisting of demolding agents, thermal stabilizers, antistats, pigments and brighteners.

5. A transparent molded article having a wall thickness of not more than 3 mm and a flow distance to wall thickness ratio of 180 to 500, composed of a composition based on aromatic polycarbonate and comprising polycarbonate having a mean weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, wherein the polycarbonate comprises 0 to not more than 19 mol % of carbonate units of the formula (1) 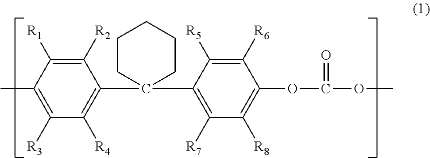
where R₁, R₂, R₃, R₄, R₅, R₆, R₇ and R₈ are independently H or C₁- to C₆-alkyl, and comprising 0% to less than 0.2% by weight of a UV absorber or a UV absorber mixture.

6. The transparent molded article of claim 5, wherein the maximum wall thickness of the molded article is 1.9 mm.

7. The transparent molded article of claim 5, wherein the flow distance to wall thickness ratio is 250 to 500.

8. The transparent molded article of claim 5, wherein the polycarbonate includes at least 98 mol % of bisphenol A-based carbonate units, based on the total amount of carbonate units.

9. The transparent molded article of claim 5, wherein the molded article is a headlamp cover.

10. A headlamp comprising a transparent molded article of claim 9 and a light source which is an LED light source.

11. A process for producing the transparent molded article of claim 5, comprising the following steps:
(i) providing a composition based on aromatic polycarbonate, comprising
a) aromatic polycarbonate, where the polycarbonate has a weight-average molecular weight M_{w} of 22 000 g/mol to 27 000 g/mol, determined by means of gel permeation chromatography to DIN 55672-1:2007-08, calibrated against bisphenol A polycarbonate standards using dichloromethane as eluent, and where the polycarbonate includes 0 to not more than 19 mol % of carbonate units of the formula (1) 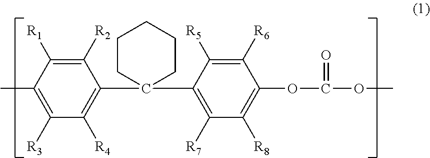
where R₁, R₂, R₃, R₄, R₅, R₆, R₇ and R₈ are independently H or C₁- to C₆-alkyl,
and
b) 0% to less than 0.2% by weight of a UV absorber or a UV absorber mixture, based on the total weight of the composition based on aromatic polycarbonate,
(ii) forming a molded article by injection molding of the molten composition based on aromatic polycarbonate from step (i), where the melt of the composition based on aromatic polycarbonate is at a temperature of greater than 300 to 380° C.

12. The process of claim 11, wherein the melt of the composition based on aromatic polycarbonate is at a temperature of greater than 330° C. to 360° C.

13. The process of claim 11, wherein the specific injection pressure is not more than 2500 bar.

14. The process of claim 11, wherein the transparent molded article has a flow distance to wall thickness ratio of 190 to 450.

15. The process of claim 11, wherein the transparent molded article is a headlamp cover.
